(19) United States
(12) Patent Application Publication
(10) Pub. No.: US 2008/0235802 A1
(43) Pub. Date: Sep. 25, 2008

(54) Software Tamper Resistance Via Integrity-Checking Expressions

(75) Inventors: Ramarathnam Venkatesan, Redmond, WA (US); Mariusz H. Jakubowski, Bellevue, WA (US); Prasad G. Naldurg, Bangalore (IN)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/689,188

(22) Filed: Mar. 21, 2007

(51) Int. Cl. H04N 7/16

(52) U.S. Cl. 726/26

(57) ABSTRACT

Implementation of software tamper resistance via integrity checks is described. In one implementation, a tamper resistance tool receives an input program code and generates a tamper-resistant program code using integrity checks. The integrity checks are generated by processing the input program code, and the integrity checks are inserted in various locations in the input program code. Values of the integrity checks are computed during program execution to determine whether a section of the program has been tampered with. Values of the integrity checks may be stored and accessed at any point during execution of the program.

### BACKGROUND

Proprietary programs often need to be protected from reverse-engineering, pirating, and tampering by persons who desire to undermine the integrity of the programs' operation. Even programs for software monitoring, such as copy protection, software licensing, and Digital Rights Management (DRM) applications require protection of crucial code and data, particularly at runtime.

By understanding the operation of a program, hackers are able to access the underlying program code and make unauthorized changes to the program. These changes can include subversion of license checks, the inclusion of viruses into the program code, and the removal of protection from various files with which the program interacts, including audio and video files.

### SUMMARY

Implementation of software tamper resistance via integrity checks is described. In one implementation, a tamper resistance tool receives an input program code and generates a tamper-resistant program code using integrity checks. The integrity checks are generated by processing the input program code, and the integrity checks are inserted in various locations in the input program code. Values of the integrity checks are computed during program execution to determine whether a section of the program has been subjected to tampering. Values of the integrity checks may be stored and accessed at any point during execution of the program.

This summary is provided to introduce a selection of concepts that are further described below in the detailed description. This summary is not intended to identify key features or essential features of the claimed subject matter, nor is it intended to be used as an aid in determining the scope of the claimed subject matter.

### BRIEF DESCRIPTION OF THE CONTENTS

The detailed description is described with reference to the accompanying figures. In the figures, the left-most digit of a reference number identifies the figure in which the reference number first appears. The use of the same reference numbers in different figures indicates similar or identical items.

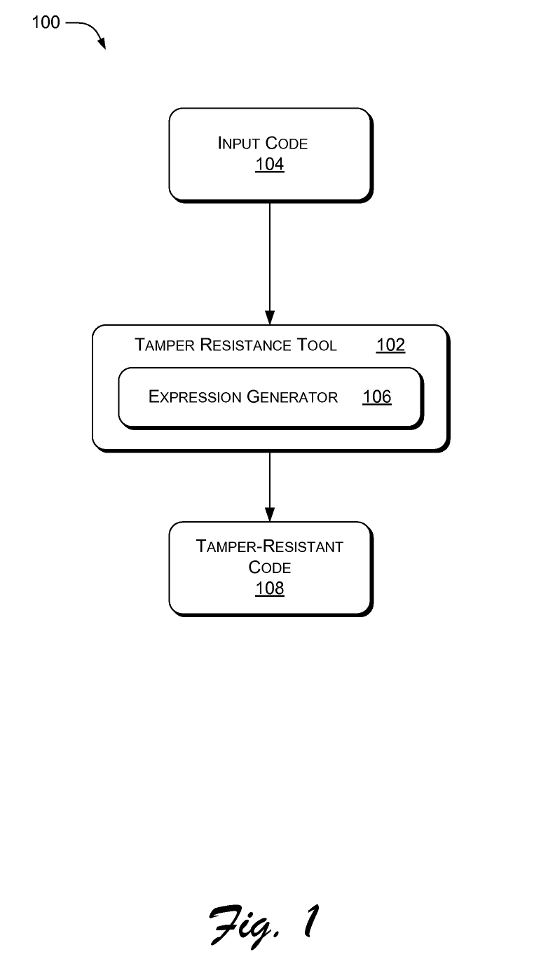

FIG. 1 illustrates an exemplary environment in which software tamper resistance via integrity checks may be implemented.

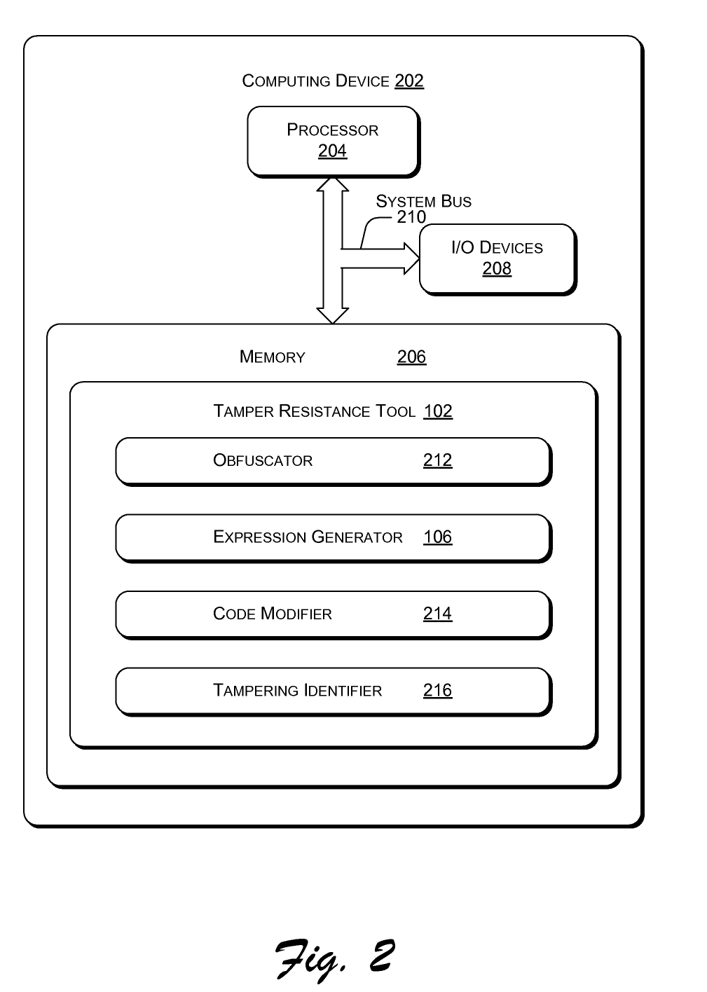

FIG. 2 illustrates a computing device including an exemplary tamper resistance tool.

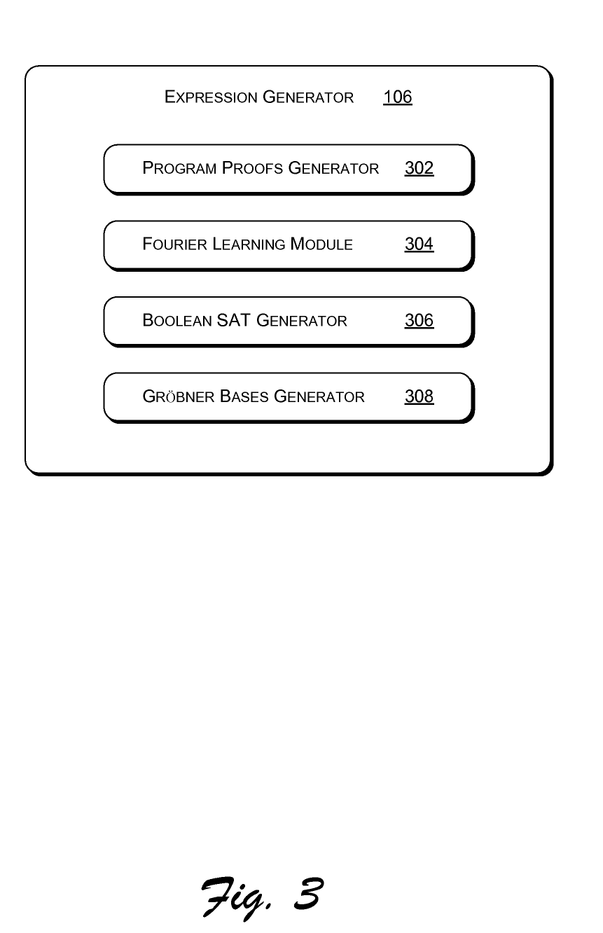

FIG. 3 illustrates an exemplary expression generator.

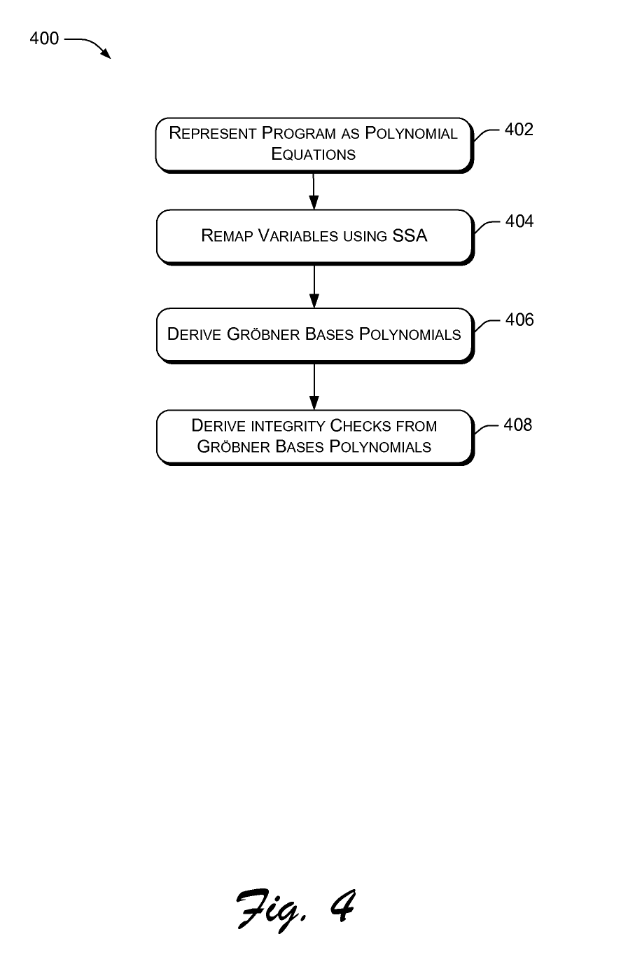

FIG. 4 illustrates an exemplary process for generating integrity checks using Gröbner bases.

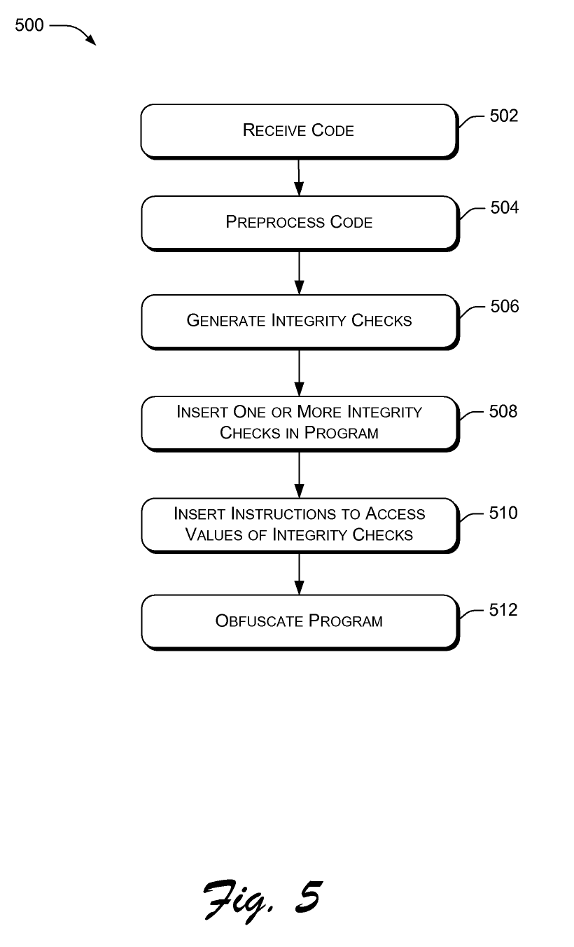

FIG. 5 illustrates an exemplary process for creating a tamper-resistant code.

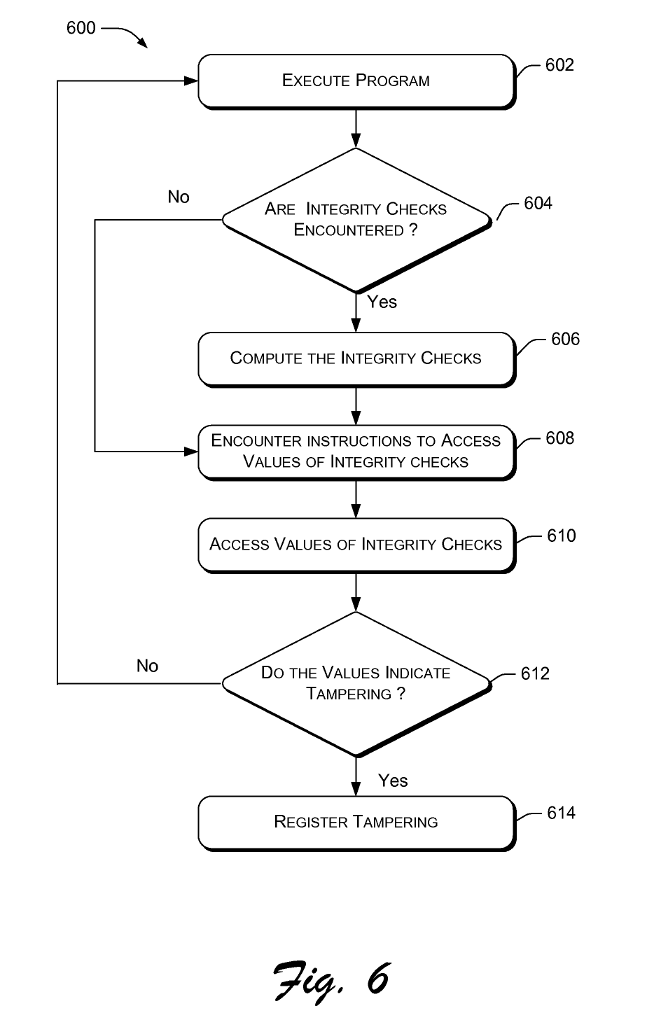

FIG. 6 illustrates an exemplary process for implementing tamper resistance via integrity checks during program execution.

### DETAILED DESCRIPTION

This disclosure is directed to techniques for implementing software tamper resistance via integrity checks and/or integrity checking expressions. More particularly, the techniques described herein involve generating integrity checks and/or integrity checking expressions, and the use of the integrity checks and/or integrity checking expressions to detect tampering with a program. The techniques described herein are machine independent and make programs self-checking by verification of intermediate results of program computation at runtime.

The terms “integrity check” and “integrity checking expression” are used interchangeably below to signify anything that can be used to check the integrity of a program. For example, either or both of the terms “integrity check” and “integrity checking expression” can be used to signify a predicate which can evaluate to either true or false to indicate the presence of tampering with a program if tampering occurs with a program. In one instance, the presence of tampering is indicated only if there is a high probability that tampering with the program did indeed occur. Additionally, either or both of the terms “integrity check” and “integrity checking expression” can be used to signify program code which evaluates an integrity checking expression and makes a decision based on the evaluation.

### Exemplary Environment

FIG. 1 shows an exemplary environment 100 suitable for implementing software tamper resistance via integrity checks. Environment 100 includes a tamper resistance tool 102 configured to impart tamper resistance functionality to an input code 104. In one implementation, tamper resistance tool 102 uses an expression generator 106 to produce tamper-resistant code 108 by inserting integrity checks into input code 104.

Tamper resistance tool 102 may be stored wholly or partially on any of a variety of computer-readable media, such as random access memory (RAM), read only memory (ROM), optical storage discs (such as CDs and DVDs), floppy disks, optical devices, flash devices, etc. Further, tamper resistance tool 102 can reside on different computer-readable media at different times.

Tamper resistance tool 102 may be implemented through a variety of conventional computing devices including, for example, a server, a desktop PC, a notebook or portable computer, a workstation, a mainframe computer, an Internet appliance, and so on.

In one implementation, tamper resistance tool 102 receives input code 104 from devices (such as storage devices or computing devices) coupled to a computing device implementing tamper resistance tool 102. Input code 104 may be a complete program or a part of a program that is to be provided with tamper resistance functionality. Input code 104 may also include conventionally used program code for software protection, as well as data associated with the execution of program code.

Tamper resistance tool 102 can preprocess input code 104 to increase program complexity and create interrelationships that can be used by tamper resistance tool 102 to generate integrity checks. Preprocessing of input code 104 can be achieved by any method known in the art, including adding inconsequential lines of code or chaff code to input code 104, code duplication within input code 104, etc.

Tamper resistance tool 102 can generate integrity checks from input code 104 using expression generator 106. Integrity checks include any type of integrity check disclosed below as well as any integrity check or integrity checking expression known in the art.

Integrity checks can be generated from input code 104 by expression generator 106 with or without preprocessing of input code 104. In one implementation, an integrity check can be a probabilistic predicate associated with a particular section of program code in input code 104. Such an integrity check can be used to determine whether the particular section of program code was executed without code or data tampering.

Different types of integrity checks can be used to detect different types of tampering. In one possible implementation, an integrity check yields a true value if no tampering has occurred during execution of a particular section of program code with which the integrity check is associated. Alternately, if tampering has occurred during execution of the particular section of program code with which the integrity check is associated, the integrity check can yield a false value with a high probability. The probability of an integrity check yielding a false value is limited by the ability of the integrity check to detect different forms of tampering.

In one implementation, integrity checks can be generated from program invariants and/or path verification conditions (PVCs) that are known in the art for building program verification proofs. In other implementations, integrity checks can be generated using Gröbner bases, Fourier machine learning, or Boolean satisfiability expressions. In yet another implementation, integrity checks can be generated by a combination of any of the above mentioned techniques. The generation of integrity checks will be discussed in more detail in conjunction with FIG. 3.

Tamper resistance tool 102 can insert integrity checks generated by expression generator 106 at various locations in input code 104 while transforming input code 104 into tamper-resistant code 108. When tamper-resistant code 108 is executed and an integrity check is encountered, a value of the integrity check is computed. The computation of integrity check values can be indistinguishable from other operations of tamper-resistant code 108.

Once computed, values of integrity checks in tamper-resistant code 108 can be stored in a memory location associated with the integrity checks. Alternately, the values of the integrity checks can be communicated to, for example, a processor or memory remote from the integrity checks. Values for integrity checks associated with a particular section of tamper-resistant code 108 can be called and examined at any time during program execution. In this way, it can be verified if a particular section of tamper-resistant code 108 was executed without code or data tampering during a given time interval.

If the values of the integrity checks associated with a particular section of tamper-resistant code 108 indicate tampering with tamper-resistant code 108, tamper resistance tool 102 can register tampering with tamper resistant code 108 and issue one or more responses. The one or more responses can include regulating execution of tamper resistant code 108 such as by termination of the execution of tamper-resistant code 108, degradation of the execution of tamper-resistant code 108, unreliable execution of tamper-resistant code 108, the issuance of an error message, and so on. Moreover, tamper resistance toot 102 can ameliorate the effects of tampering, thus restoring tamper-resistance code 108 to a state tamper-resistant code 108 was at before tampering occurred.

Since values for integrity checks associated with a particular section of tamper-resistant code 108 can be called and examined at any time during program execution, a response by tamper resistance tool 102 to a failed integrity check can occur after any activity which resulted in the failed integrity check. In this way, a cause-effect link between the activity resulting in the failed integrity check and the resulting responses issued by tamper resistance tool 102 can be masked in time and space.

### Exemplary Computing Device

FIG. 2 illustrates various components of an exemplary computing device 202 suitable for implementing tamper resistance tool 102. Computing device 202 can include a processor 204, a memory 206, input/output (I/O) devices 208 (e.g., keyboard, display, and mouse), and a system bus 210 operatively coupling various components of computing device 202.

System bus 210 represents any of several types of bus structures, including a memory bus or memory controller, a peripheral bus, an accelerated graphics port, and a processor or local bus using any of a variety of bus architectures. By way of example, such architectures can include an industry standard architecture (ISA) bus, a micro channel architecture (MCA) bus, an enhanced ISA (EISA) bus, a video electronics standards association (VESA) local bus, a peripheral component interconnects (PCI) bus also known as a mezzanine bus, a PCI express bus, a universal serial bus (USB), a secure digital (SD) bus, or an IEEE 1394 (i.e., FireWire) bus.

Memory 206 can include computer-readable media in the form of volatile memory, such as RAM and/or non-volatile memory, such as ROM, or flash RAM. Memory 206 can include data and program modules for implementing software tamper resistance via integrity checks which are immediately accessible to, and presently operated on, by processor 204.

In one embodiment, memory 206 includes tamper resistance tool 102. Tamper resistance tool 102 can include an obfuscator 212, expression generator 106, a code modifier 214, and a tampering identifier 216.

Obfuscator 212 can preprocess input code 104 received by tamper resistance tool 102 to increase program complexity of input code 104 and create interrelationships between program variables in input code 104. Preprocessing can be implemented at a high level such as at a source-code-level, or at a lower level, such as at a binary-level. For example, obfuscator 212 can use a source-to-source transformation tool along with a binary relinker to preprocess input code 104.

In one implementation, preprocessing input code 104 includes inserting inconsequential lines of code, such as chaff code, into input code 104. Inconsequential lines of codes added in this manner to input code 104 may be configured to perform computations using a combination of existing and new program variables.

In another possible implementation, preprocessing input code 104 includes inserting duplicate lines of existing lines of program code in input code 104. Such an implementation can include the individualization of the duplicate lines of existing lines of program code.

Input code 104, whether subjected to preprocessing or not, can also be subjected to tamper resistance functionalities, transforming input code 104 into tamper-resistant code 108. For example, expression generator 106 can generate integrity checks corresponding to various sections of program code in input code 104, and code modifier 214 can insert the integrity checks, as well as instructions to access values of the integrity checks, at various locations in input code 104.

In one implementation, expression generator 106 can generate integrity checks from program invariants and/or path verification conditions (PVCs) which are known in the art for building program verification proofs. In other implementations, expression generator 106 can generate integrity checks using, for example, Gröbner bases, Fourier machine learning, or Boolean satisfiability expressions. Moreover, expression generator 106 can generate integrity checks using a combination of any of the above mentioned techniques.

Code modifier 214 inserts integrity checks generated by expression generator 106 at various locations in input code 104. The various locations in input code 104 can include combinations of security-critical locations (such as a locations corresponding to license validation) and non-security-critical locations. Computation of an integrity check results in a value for the integrity check which can immediately be accessed and viewed, or which can be stored and accessed during a later stage of execution of tamper-resistant code 108. For example, an integrity check can yield a true value if no tampering has occurred during execution of a particular section of code with which the integrity check is associated. Else, if tampering has occurred during execution of the particular section of code with which the integrity check is associated, the integrity check can yield a false value with a high probability. Values computed for the integrity checks can be stored with the integrity checks themselves, or the values can be stored remote from the integrity checks.

Code modifier 214 can also insert lines of program code into input code 104 which include instructions to access values of integrity checks inserted into input code 104. Integrity checks inserted into the input code 104 can thus be called at anytime during execution of input code 104, and values for the integrity checks can be used to verify that a particular section of tamper-resistant code 108 has been executed without code or data tampering during a given time interval. Further, values of one or more integrity checks can be accessed at any time during execution of tamper-resistant code 108. For example, a value for an integrity check can be calculated at one point of execution of tamper-resistant code 108, and then the value of the integrity check can be accessed at a later point of execution of tamper-resistant code 108.

Accessing values of integrity checks inserted into input code 104 can also be instigated by tampering identifier 216. In FIG. 2, tampering identifier 216 is illustrated as residing within tamper resistance tool 102. It will also be understood, however, that tampering identifier 216 may reside at one or more of several different locations, including outside of tamper resistance tool 102.

For example, in one implementation, tampering identifier 216 may reside within tamper-resistant code 108 as lines of program code. In such an implementation, instructions associated with tampering identifier 216 can include commands to access the values of integrity checks in tamper-resistant code 108.

Alternately, tampering identifier 216 may exist separately from the tamper-resistant code 108. In such an implementation, tampering identifier 216 can be called during program execution through use of mechanisms such as a pointer indicating a memory location at which tampering identifier 216 resides.

In operation, when execution of tamper-resistant code 108 arrives at a section of program code including instructions to access values of integrity checks, tampering identifier 216 accesses the values. Values for integrity checks computed earlier during program execution may be stored with the integrity checks themselves, or the values may be stored remotely from the integrity checks. Similarly, if no value has been computed for an integrity check, tampering identifier 216 may instigate computation of the value of the integrity check.

Tampering identifier 216 can examine the accessed values of the integrity checks and register tampering if one or more of the integrity checks fail. Failure of an integrity check can occur when the value of the integrity check computed during program execution is false.

In one implementation, tampering is registered if one or more of the integrity checks fail. In another implementation, tampering is registered if all the integrity checks fail. In yet another implementation, tampering is registered if a pre-set minimum number of integrity checks fail. In one implementation, the minimum number of integrity checks that are required to fail to register tampering can be set as a percentage of integrity checks accesses at a particular time. In such an implementation, the minimum number of integrity checks that are required to fail to register tampering can be varied by changing the number of values of integrity checks accessed at a particular time.

Once tampering identifier 216 registers tampering, one or more responses may be initiated by tampering identifier 216. For example, the execution of tamper-resistant code 108 can be terminated. Alternately, tamper-resistant code 108 may be unreliably executed, or the execution of tamper-resistant code 108 may be degraded. In yet another implementation, an error message may be displayed. Moreover, tampering identifier 216 can repair or undo tampering with tamper-resistant code 108.

It will be understood that obfuscator 212 can obfuscate input code 104 at any time while input code 104 is being transformed to tamper-resistant code 108, and after tamper-resistant code 108 has been created. For example, after the creation of tamper-resistant code 108, obfuscator 212 may increase program complexity by various methods known in the art such as by adding of chaff code, duplicating existing lines of program code, etc. Alternately, both the input code 104 and the tamper-resistant code 108 can be obfuscated. Similarly, either or both of the input code 104 and the tamper-resistant code 108 can be obfuscated in successive iterations.

Moreover, processes such as obfuscation, generation and insertion of integrity checks, etc., can be performed iteratively on input code 104. In such a case, program code output from a particular iteration can serve as program code input to the next iteration. Also, integrity checks from a particular iteration can examine the veracity of integrity checks inserted in previous iterations.

It will be also be understood that the number of integrity checks inserted in input code 104 and the complexity of code preprocessing and obfuscation carried out by modules such as obfuscator 212 may vary depending upon an extent of separation desired between tampering with tamper-resistant code 108 and registration of tampering with tamper-resistant code 108 by tamper-resistant code 108 by tamper resistance tool 102.

In one embodiment, a user can input various configuration parameters, such as desired security level for tamper-resistant code 108, a number of iterations of obfuscation of input code and/or tamper-resistant code 108, and an allowable code size for tamper-resistant code 108. It is possible that a time required to execute and obtain results from tamper-resistant code 108 may be greater than a time required to execute input code 104 and obtain the same results. This can occur due to obfuscation and integrity checks added to input code and tamper-resistant code 108. In such a case, tamper resistance functionalities can be seen to impose speed penalties on input code 104 as input code 104 is transformed into tamper-resistant code 108. In one implementation, speed penalties imposed on input code 104 can be regulated by a user. For example, the user can input maximum speed penalties which can be imposed on input code 104 as input code 104 is transformed into tamper-resistant code 108. Additionally, the user can be allowed to regulate and/or limit the types of obfuscation, which can be applied to input code and/or tamper-resistant code 108. Alternately, tamper resistance tool 102 can use default or random values of configuration parameters to regulate speed penalties on input code 104 as input code 104 is transformed into tamper-resistant code 108.

It will also be understood that intermediate lines of program code and instructions, as well as data generated during the transformation of input code 104 into tamper-resistant code 108, can be stored at various memories, including memory 206. Additionally, the data and various intermediate lines of program code and instructions may be stored at various memories at various times.

### Exemplary Expression Generator

FIG. 3 illustrates various components of an exemplary expression generator 106 configured to generate integrity checks using one or more of a program proofs generator 302, a Fourier learning module 304, a Boolean SAT generator 306, and a Gröbner bases generator 308.

Program proofs generator 302 generates program invariants and path verification conditions using methods known in the art for program verification. A program invariant is a statement of a program that is true at any point of time during execution of the program. A path verification condition is a statement associated with a program that is true at a particular time during program execution, but which may be false at any other time during program execution. For example, for a section of program code that sorts a list of variables, a path verification condition may be to check whether the list of variables is in order. The path verification condition could yield a true value if the list is in order, i.e., after the section of program code was executed correctly. Alternately, in the event the list is not in order, the path verification condition could yield a false value.

Failure of a path verification condition can occur for various reasons. For example, a path verification condition can fail if the path verification condition is computed before execution of a section of program code with which the path verification condition is associated. Similarly a path verification condition can fail if a section of program code with which the path verification condition is associated fails to completely or correctly execute. Still further, a path verification condition can fail if a section of program code with which the path verification condition is associated has been tampered with.

Program invariants and path verification conditions can be generated by program proofs generator 302 for different sections of input code 104. In this way program invariants and path verification conditions generated by program proofs generator 302 can be consistent with valid paths of execution for different program inputs as sections of input code 104 are executed (once input code 104 has been transformed into tamper-resistant code 108). Program invariants and path verification conditions need not be constrained to be global properties of tamper-resistant code 108. Therefore program invariants and path verification conditions can be used to check complex properties of individual paths of execution of tamper-resistant code 108.

Program proofs generator 302 can also generate integrity checks from program invariants and path verification conditions by creating predicate expressions. Predicate expressions can be created by combining program invariants and path verification conditions such that the predicate expressions can be evaluated to yield a true or false value depending upon values of the program invariants and the path verification conditions. Thus integrity checks can be computed at runtime to verify whether sections of tamper-resistant code 108 with which the predicate expressions are associated, have been executed without tampering.

Fourier learning module 304 generates integrity checks using Fourier machine learning techniques. In machine learning, an unknown function can be learned based on a set of correct inputs and outputs for the unknown function. A system can be trained on the set of correct inputs and outputs to determine outputs corresponding to inputs that were not used before.

In particular, Fourier learning module 304 converts program fragments or program code sections into arrays of Fourier coefficients. These arrays can serve as parts of program invariants and/or path verification conditions that compare functions represented by the original program fragments with learned versions of the functions. Fourier learning module 304 generates integrity checks based on these program invariants and/or path verification conditions.

For example, fragments or program code sections of input code 104 (and subsequently of tamper-resistant code 108) can be treated as Boolean functions of n-bits that receive variables as inputs, process the variables, and produce an output. A single bit at a time can be taken from a value of a variable computed in a program code fragment of input code 104. An output of the program code fragment can then be learned using Fourier learning or any machine learning techniques known in the art.

At runtime, actual output from the program code fragment of tamper-resistant code 108 can be compared with output from a learned version of the program fragment of tamper-resistant code 108 to verify whether the program fragment executed without tampering.

Boolean SAT generator 306 generates integrity checks based on Boolean SAT (satisfiability) representations of code sections of input code 104 (and subsequently of tamper-resistant code 108). Code sections of input code 104 can be converted into Boolean low-level representations, called Boolean SAT formulas. A Boolean SAT formula is an expression of Boolean variables that uses a satisfying assignment; i.e., an assignment which renders an expression true. Boolean SAT generator 306 derives integrity checks by transforming or simplifying Boolean SAT formulas corresponding to sections of program code in input code 104 (and subsequently in tamper-resistant code 108).

Gröbner bases generator 308 generates integrity checks using Gröbner bases polynomials derived from code sections of input code 104 (and subsequently of tamper-resistant code 108). Gröbner bases generator 308 represents a section of tamper-resistant code 108 as a sequence of polynomials. Variables in the sequence of polynomials are remapped using static single assignment (SSA) to form SSA remapped polynomials. Gröbner bases polynomials can be derived from the SSA remapped polynomials using any method known in the art.

A Gröbner basis is a particular kind of generating subset of an ideal I in a polynomial ring R. A polynomial ring R over k is a set of polynomials with coefficients in a ring. The ring R is equipped with two binary operations where “+” denotes addition and “.”, denotes multiplication, such that (R,+) is an Abelian group with identity 0 and (R,.) is a monoid with identity IεR, and . distributes over +. An ideal I of R is a special subset of the ring B. A subset I of B is called an ideal if (I,+) is a subgroup of (R,+) and ∀xεI, rεR, r.xεI (also x.rεR provided R is commutative). A Gröbner basis is defined with respect to a fixed monomial ordering, such as o on n variables in the ring R. A Gröbner basis of I can be denoted by G. Thus, G can be written as G:={g₁, . . . , gₘ}, for some polynomials gᵢ, such that <G>=I.

Since polynomials in a Gröbner basis have the same collection of roots as the original polynomials (i.e., the sequence of SSA remapped polynomials generated by Gröbner bases generator 308), it follows that the set of states or input values that evaluate to zero for a Gröbner basis is identical to the set of states or input values that evaluate to zero for the original polynomials. Therefore, a Gröbner basis can be used to generate path verification conditions that abstract program behavior with respect to a fixed monomial ordering.

As noted above, Gröbner bases generator 308 generates Gröbner basis polynomials for a program code section P of input code 104 by using static single assignment (SSA) remapping. In SSA remapping, Gröbner bases generator 308 transforms an ordered sequence of program statements in the program code section P into an equivalent set of polynomials by introducing temporary variables. For example, if a program variable x is updated, each new assignment of x is replaced with a new variable in all expressions between the current assignment and the next assignment. The program code section P can then be represented as a set of polynomials, with each polynomial in the set of polynomials corresponding to an assignment statement in P. An ideal P′ is associated with the program code section P and Gröbner basis polynomials are generated as subsets of the ideal P′.

For example, in one implementation, Gröbner bases generator 308 generates Gröbner bases polynomials for a section of input code 104 as explained below. Let input and output variables of the section of input code 104 be {x, y, z} and the section of input code 104 can include the following assignment statements:

x=x+y+z;

y=y+5;

z=x+1;

x=x+1;

In order to treat the assignment statements as equations, the assignment statements can be transformed using SSA into the following:

x₁=x₀+y₀;

x₂=x₁+z₀;

y₁=y₀+5;

z₁=x₂+1;

x₃=x₂+1;

Further, the following polynomial set can be obtained from the above equations:

I=<x₁−x₀−y₀,x₂−x₁−z₀,y₁−y₀−5,z₁−x₂−1,x₃−x₂−1>

A Gröbner basis of this polynomial set with respect to a fixed monomial order {x₀<x₁<x₂<x₃<y₀<y₁<z₁} can be generated by Gröbner bases generator 308 to give:

G={5+y₀−y₁,x₃−z₁,1+x₂−z₁,1+x₁+z₀−z₁,−4+x₀+y₁+z₀−z₁}

When the monomial order is changed, a different Gröbner basis can be obtained. For example, for the ordering {z₀<y₀<y₁<x₀<x₁, x₂<x₃} of the Gröbner basis can be given by:

G={x₃−z₁,1+x₂−z₁,−5+x₀−x₁+y₁,x₀−x₁+y₀,1+x₁+z₀−z₁}

For both of the above cases, the Gröbner basis polynomials evaluate to zero for any correct valuations to input variable x₀, y₀, and z₀. However, if the output is changed (simulated by changing some intermediate outputs) then the above polynomials may not evaluate to zero.

In another implementation, Gröbner bases generator 308 implements an SSA-remapping tool that converts C++ code into polynomials suitable for Gröbner basis computation. Consider the following section of input code 104:

x=b²+2a−17c;

y=x+3ab;

z=19b−18yx²;

y=x+2y−z;

After processing the above, the SSA-remapping tool generates the following polynomials:

t154−(b0*b0),

t155−(2*a0),

t156−(t154+t155),

t157−(7*c0),

t158−(t156−t157),

x0−t158,

t159−(3*a0),

t160−(15*b0),

t161−(x0+t160),

y0−t161,

t162−(19*b0),

t163−(18*y0),

t164−(t163*x0),

t165−(t164*x0),

t166−(t162−t165),

z0−t166,

t167−(2*y0),

t168−(x0+t167),

t169−(t168−z0),

y1−t169

In the above polynomials, variables with names prefixed by ‘t’ (e.g., t154) are new temporaries introduced by the SSA-remapping tool. Original variables (e.g., y) are extended with numerical suffixes to create SSA-remapped versions (e.g., y0,y1). The following Gröbner basis can be obtained by Gröbner bases generator 308 for the above polynomials by eliminating variables t154 through t169:

x₀+2y₀−y₁−z₀,

2a₀+b₀²−17c₀+2y₀−y₁−z₀,

3a₀b₀−3y₀+y₁+z₀,

6a₀²−51a₀c₀+6a₀y₀+3b₀y₀−3a₀y₁−b₀y₁−3a₀z₀−b₀z₀,

−19b₀+72y₀³−72y₀²y₁+18y₀y₁²+z₀−72y₀²z₀+36y₀y₁z₀+18y₀z₀²

The above basis polynomials evaluate to zero on any set of proper assignments to the variables a₀, b₀, c₀, x₀, y₀, z₀, and y₁. For example, if
a₀=3
b₀−14
c₀=15

### Then,

x₀=−53
y₀=73
z₀=−3690760
y₁=3690853,
   and each basis polynomial evaluates to zero on these assignments. However, if an attack occurs or a programmer tampers with these values, this will no longer hold. For example, if the value of y₀ is changed from 73 to 72, the five basis polynomials evaluate to {−2,−2,3,−60,−320130).

In another possible implementation, when a section of input code 104 includes conditional statements, verification conditions sets can be independently computed by Gröbner bases generator 308 for each branch path. Further, a cross product of the verification conditions sets can be computed. Since all polynomials in at least one verification condition set evaluate to zero during correct execution, the computed cross product also vanishes. For example, consider the following C++ code section as a section of input code 104:

```
if (...)
{
  x = b*b − 17*a*b;
  x = x − 3*x*c;
}
else
{
  x = b*b − 2*a + 17*c;
  y = x + 2*a*b;
}
```

Polynomials corresponding to the two branch paths (If branch and Else path) are as follows:

x₀−b²+17ab,

x₁−x₀+3x₀c

and

x₀−b₂+2a−17c,

y−x₀−2ab

Gröbner bases corresponding to the respective sets of polynomials are as follows:

−x₀+3cx₀+x₁,

17ab−b²+x₀

and

−2a+b²+17c−x₀,

2ab+x₀−y,

4a²−34ac+2ax₀+bx₀−by

A cross product of these bases includes 6 polynomials, each of which evaluate to zero on any variable assignment. The 6 polynomials can be as follows:

(x₀+3cx₀+x₁)(−2a+b²+17c−x₀),

(−x₀+3cx₀+x₁)(2ab+x₀−y),

(−x₀+3cx₀+x₁)(4a²−34ac+2ax₀+bx₀−by),

(17ab−b₂+x₀)(2a+b²+17c−x₀),

(17ab−b²+x₀)(2ab+x₀−y),

(17ab−b²+x₀)(4a²−34ac+2ax₀+bx₀−by)

Thus, execution of each branch path can be ascertained using the above polynomials. In addition, to verify that a proper path was chosen according to the conditional statement in the code section, the conditional statement itself can be treated as a polynomial for Gröbner basis and integrity-check generation.

Further, to handle a loop in a program code section, the Gröbner bases generator 308 can compute a Gröbner basis for the loop body. Also, loop variables and conditions can be included in a set of input polynomials. Alternately, loops can be unrolled to produce new instances of loop variables for each iteration of the loop.

In yet another implementation, Gröbner bases can be computed by Gröbner basis generator 308 for small, randomly overlapping fragments of code within a larger code section. Various combinations of the resulting verification conditions can be used to generate integrity checks. For example, consider the following C++ code segment as a section of input code 104:

x=b*b+2*a−17*c;

y=x+3*a*b;

z=19*b−18*y*x*x;

y=x+2*y−z;

The above code segment can be split into overlapping fragments below:

x=b*b+2*a−17*c;

y=x+3*a*b;

z=19*b−18*y*x*x,

and

y=x+3*a*b;

z=19*b−18*y*x*x;

y=x+2*y−z;

A Gröbner basis can then be computed for each overlapping fragment separately.

In another implementation, program code behavior can be analyzed by Gröbner basis generator 308 without making any assumptions on input-output models. Consider an input code 104 including the following polynomials:

Q={x₁−2a+b+c,x₂−17a+b−7c−10,x₃−5b+a+2,x₄+18a−7b+c−14}

A Gröbner basis with {a, b, C} eliminated from the above polynomials can be determined to be −3154+497x₁+92x₂−88x₃+147×4. This Gröbner basis evaluates to zero for any assignments to input variables. The basis polynomial can reduce modulo a prime as follows:

p=2:{x₁+x₄}

p=3:{2+2x₁+2x₂+2x₃}

p=5:{1+2x₁+2x₂+2x₃+2x₄}

p=7:{3+x₂+3x₃}

p=11:{3+2x₁+4x₂+4x₄}

p=13:{5+3x₁+x₂+3x₃+4x₄}

p=17:{8+4x₁+7x₂+14x₃+11x₄}

p=19:{3x₁+16x₂+7x₃+14x₄}

p=23:{20+14x₁+4x₃+9x₄}

p=101:(78+93x₁+92x₂+13x₃+46x₄}

When the outputs or variables are modified slightly, the bases evaluate to zero every (1/p) times on an average. For example,

with p=2:
{0}{1}{0}{1}{0}{1}{0}{1}{0}{1}{0}{1}{0}{1}{0}{1}{0}{1}{0}{1}{0}{1}{0}{1}{0} . . .
   With p=11:
{0}{2}{4}{6}{8}{10}{1}{3}{5}{7}{9}{0}{2}{4}{6}{8}{10}{1}{3}{5}{7}{9}{0}{2}{4} . . .
   With p=101:
{13}{40}{67}{94}{20}{47}{74}{0}{27}{54}{81}{7}{34}{61}{88}{14}{41}{68}{95}{21}{48}{75}{1}{28}{55} . . .

Thus, as illustrated above using various exemplary implementations, Gröbner bases generator 308 can generate integrity checks for a section of input code 104 (and subsequently of tamper resistant code 108) using Gröbner bases polynomials derived from the section of input code 104.

In addition to generating Gröbner bases polynomials derived from code sections of input code 104 (and subsequently tamper-resistant code 108), Gröbner bases generator 308 can generate integrity checks for a section of input code 104 from the Gröbner bases derived for the section of input code 104.

### Exemplary Processes

FIG. 4 illustrates an exemplary process 400 used by Gröbner bases generator 308 to generate integrity checks using Gröbner bases polynomials. Process 400 is illustrated as a collection of blocks in a logical flow graph representing a sequence of operations that can be implemented in hardware, software, firmware or a combination thereof. The order in which the methods are described is not intended to be construed as a limitation, and any number of the described method blocks can be combined in any order to implement the methods, or alternate methods. Additionally, individual blocks may be deleted from the methods without departing from the spirit and scope of the subject matter described herein. In the context of software, the blocks represent computer instructions that, when executed by one or more processors, perform the recited operations.

At block 402, a program or a program code section, such as from input code 104 and/or tamper-resistant code 108 is represented as a sequence of polynomials that can be computed to be equal to zero. In one implementation, the sequence of polynomials can be created by Gröbner bases generator 308.

For example, equations in a straight line program can be represented as polynomials as follows:

x=y+2→x−(y+2)

y=150+z*z→y−(150+z*z)

x=2*y→x−2*y

At block 404, variables in the sequence of polynomials found at block 402 are remapped using SSA to ensure that every variable is assigned once in a code path. For example, the variable of polynomials can be remapped using an SSA remapping tool in Gröbner bases generator 308.

In this way, if a variable is assigned multiple times in a code path, separate instances or copies are of the variables are created for each assignment, such that a variable is not overwritten during execution. Since SSA remapped polynomials are generated from polynomials that can be computed to be equal to zero, the SSA remapped polynomials can also be computed to be equal to zero. For example, the polynomials created above can be remapped using SSA to generate polynomials as shown below:

x−(y+2)→x₁−(y₁+2)

y−(150+z*z)→y₂−150−z*z

x−2*y→x₂−2*y₂

At block 406, Gröbner bases polynomials are generated from the SSA remapped polynomials using methods known in the art. Gröbner bases polynomials are polynomials (such as P₁(x₁, y₁, z), P₂(x₁, y₁, z), etc.) that can also be computed to be equal to zero at runtime, and therefore can be used to generate integrity checks for verifying program code execution.

At block 408, integrity checks can be generated from the Gröbner bases polynomials by methods such as randomly combining the Gröbner bases polynomials, reducing mod random primes of the Gröbner bases polynomials, combining Gröbner bases polynomials with chaff code, etc.

FIG. 5 illustrates an exemplary process 500 for inserting integrity checks in a program to implement software tamper resistance via integrity checks. Process 500 is illustrated as a collection of blocks in a logical flow graph representing a sequence of operations that can be implemented in hardware, software, firmware or a combination thereof. The order in which the method is described is not intended to be construed as a limitation, and any number of the described method blocks can be combined in any order to implement the method, or an alternate method. Additionally, individual blocks may be deleted from the method without departing from the spirit and scope of the subject matter described herein.

In the context of software, the blocks represent computer instructions that, when executed by one or more processors, perform the recited operations. For discussion purposes, the process 500 is described with reference to environment 100 shown in FIG. 1, and tamper resistance tool 102 shown in FIG. 2.

At block 502, input code, such as input code 104, is received. The input code may be a complete program or a part of a program that is to be provided with tamper resistance functionality. The input code may also include conventionally used program code for software protection, as well as data associated with execution of program code.

At block 504, the input code can be preprocessed to increase complexity and create inter-relationships between variables in the input code. In one implementation, the input code 104 is preprocessed, such as by obfuscator 212, using methods known in the art such as the addition of inconsequential lines of code or chaff code, code duplication, etc.

At block 506, integrity checks are generated for the input code. The integrity checks correspond to various sections of program code in the input code and can be used during program execution to verity whether the sections of program code were executed without any data or code tampering. For example, in one possible implementation, expression generator 106 can generate integrity checks for input code 104. Expression generator 106 can use one or more of Gröbner bases polynomials, Fourier machine learning techniques, Boolean SAT expressions, program invariants and/or path verification conditions obtained from program verification methods and proofs.

At block 508, one or more integrity checks are inserted at various locations in the input code. The locations can include security-critical parts of the input code and also some unrelated program code sections. In one implementation, code modifier 214 inserts integrity checks generated by expression generator 106 at various locations in input code 104.

At block 510, instructions to access values of the integrity checks are inserted in the input code to create a tamper-resistant code, such as tamper-resistant code 108. Thus values of integrity checks associated with a particular program code section can be called and examined at any time during execution of the tamper-resistant code. In this way, it can be verified if the particular program code section was executed without code or data tampering during a given time interval. In one implementation, code modifier 214 inserts instructions to access values of integrity checks at various locations in input code 104. In another implementation, instructions to access values of integrity checks at various locations in input code 104 are inserted as part of tampering identifier 216.

At block 512, the tamper-resistant code can be further obfuscated using any method known in the art to further increase program complexity. In one implementation, obfuscator 212 obfuscates the tamper-resistant code by introducing inconsequential lines of code to tamper-resistant code 108.

It will be understood that various parts of process 500, such as obfuscation, generation and insertion of integrity checks, etc., can be performed iteratively on the input code and the tamper-resistant code. In this approach, the integrity-checking expressions computed in each new iteration can verify the correct evaluation of integrity-checking expressions generated during all previous iterations.

FIG. 6 illustrates an exemplary process 600 that is carried out upon execution of a tamper-resistant code, such as tamper-resistant code 108. Process 600 is illustrated as a collection of blocks in a logical flow graph representing a sequence of operations that can be implemented in hardware, software, firmware or a combination thereof. The order in which the methods are described is not intended to be construed as a limitation, and any number of the described method blocks can be combined in any order to implement the methods, or alternate methods. Additionally, individual blocks may be deleted from the methods without departing from the spirit and scope of the subject matter described herein.

In the context of software, the blocks represent computer instructions that, when executed by one or more processors, perform the recited operations. For discussion purposes, the process 600 is described with reference to environment 100 shown in FIG. 1, and tamper resistance tool 102 shown in FIG. 2.

At block 602, process 600 is initiated by executing tamper-resistant program code. The tamper-resistant program code can include, for example, tamper-resistant code 108.

At block 604, program execution determines whether integrity checks are encountered. If program execution encounters integrity checks at block 604 (i.e., the “yes” branch from block 604), the integrity checks are computed at block 606 and program execution continues to block 608. Alternately, if program execution does not encounter integrity checks at block 604 (i.e., the “no” branch from block 604), no integrity checks are computed, and program execution continues to block 608.

At block 608, instructions may be encountered directing process 600 to access values of integrity checks computed at block 606.

At block 610, values of one or more integrity checks computed at block 606 are accessed in response to the instructions encountered at block 608. In one implementation, the values that are accessed are the values of integrity checks that were computed when lines of code corresponding to the integrity checks were executed during program execution, such as at block 606.

Alternately, if no values for the integrity checks have been previously computed, computation of the values is initiated when the values are to be accessed at block 610. For example, accessing of the values can be initiated by lines of code within the tamper-resistant code, or by a tampering identifier, such as tampering identifier 216.

At block 612, the values accessed at block 610 are examined to determine if program code or data from the program code being executed has been tampered with. One or more failed integrity checks, i.e., integrity checks that yield a value of false, can be considered to indicate tampering.

If the values of the integrity checks accessed at block 610 do not indicate tampering (i.e., the “no” branch from block 612), then process 600 returns to block 602 where program execution can be continued. Alternately, if the values of the integrity checks accessed at block 610 indicate tampering (i.e., the “yes” branch from block 612), then tampering is registered at block 614 and one or more tamper responses can be initiated, for example by a module such as tampering identifier 216.

For example, the execution of the tamper-resistant code can be terminated. Alternately, the tamper-resistant code can be unreliably executed, or the execution of tamper-resistant code can be degraded. In yet another implementation, an error message can be displayed. Moreover, the tampering can be identified and corrected in another implementation.

### CONCLUSION

Although embodiments of software tamper-resistance via integrity checks have been described in language specific to structural features and/or methods, it is to be understood that the subject of the appended claims is not necessarily limited to the specific features or methods described. Rather, the specific features and methods are disclosed as exemplary implementations of software tamper-resistance via integrity checks.

What is claimed is:

1. A method comprising:
processing a program to generate an integrity check;
inserting the integrity check into a location in the program;
computing a value for the integrity check at runtime of the program;
accessing the value of the integrity check; and
registering tampering with the program when the value of the integrity check is false.

2. The method of claim 1, wherein processing includes generating the integrity check using at least one of:
a program invariant;
a program verification condition;
a program proof.

3. The method of claim 1, wherein processing includes learning parts of the program by Fourier machine learning.

4. The method of claim 1, wherein processing includes representing the program as one or more Boolean satisfiability expressions.

5. The method of claim 1, wherein, processing includes:
generating polynomials for the program by single static assignment remapping; and
computing Gröbner bases for the polynomials.

6. The method of claim 5, wherein processing further includes at least one of combining two or more of the Gröbner bases, reducing mod random primes of the Gröbner bases, and obfuscating the Gröbner bases.

7. The method of claim 1, wherein inserting further comprises placing the integrity checks at security-critical locations in the program.

8. The method of claim 1, wherein accessing occurs at a time of execution of the program occurring after a time of computing of the value for the integrity check.

9. The method of claim 1 wherein registering includes one or more of:
terminating execution of the program;
degrading execution of the program;
unreliably performing execution of the program;
displaying an error message;
removing the tampering from the program.

10. A computer-readable medium having a set of computer-readable instructions that, when executed, perform acts comprising:
processing a program to generate at least one integrity check;
accessing a value of the at least one integrity check, wherein the value is computed at runtime of the program; and
registering tampering with the program depending upon the value.

11. The computer-readable medium of claim 10 having a set of computer-readable instructions that, when executed, perform acts further comprising allowing a user to input a maximum speed penalty which can be imposed on the program through generation of the at least one integrity check.

12. The computer-readable medium of claim 10 having a set of computer-readable instructions that, when executed, perform acts further comprising iteratively computing the value of the at least one integrity check.

13. The computer-readable medium of claim 10 having a set of computer-readable instructions that, when executed, perform acts further comprising processing the program to generate the at least one integrity check by at least one of:
generating a program invariant;
generating a program verification condition;
generating a program proof;
computing Gröbner bases for the program;
learning parts of the program by Fourier machine learning;
representing the program as Boolean satisfiability expressions.

14. The computer-readable medium of claim 10 having a set of computer-readable instructions that, when executed, perform acts further comprising registering tampering with the program when the value indicates tampering with the program by one or more of:
terminating execution of the program;
degrading execution of the program;
unreliably executing the program;
displaying an error message.

15. The computer-readable medium of claim 10 having a set of computer-readable instructions that, when executed, perform acts further comprising removing any effects of tampering from the program when the value indicates tampering with the program.

16. A computing device comprising:
a memory;
one or more processors operatively coupled to the memory;
an expression generator configured to generate one or more integrity checks for a program; and
a code modifier configured to insert the one or more integrity checks at one or more locations in the program, wherein values of the one or more integrity checks can be accessed at runtime and further wherein tampering with the program can be detected based on the values.

17. The computing device of claim 16 further comprising an obfuscator configured to obfuscate the program by inserting chaff code into the program.

18. The computing device of claim 16 wherein, the values of the one or more integrity checks are computed at runtime.

19. The computing device of claim 16 wherein, the expression generator is configured to generate the one or more integrity checks using at least one of:
a program invariant;
a program verification condition;
a program proof;
Gröbner bases;
Fourier machine learning;
Boolean satisfiability expressions.

20. The computing device of claim 16 further comprising a tampering identifier configured to register tampering with the program when at least one of the one or more integrity checks has a false value.
